(19) United States
(12) Patent Application Publication
(10) Pub. No.: US 2014/0031790 A1
(43) Pub. Date: Jan. 30, 2014

(54) POULTRY INJECTION APPARATUS AND METHODS

(71) Applicant: Scott C. Johnson, Blomkest, MN (US)

(72) Inventor: Scott C. Johnson, Blomkest, MN (US)

(73) Assignee: NOVA-TECH ENGINEERING, INC., Willmar, MN (US)

(21) Appl. No.: 13/980,374

(22) PCT Filed: Jan. 20, 2012
(86) PCT No.: PCT/US12/22014

§ 371 Date: Sep. 30, 2013

Related U.S. Application Data
(60) Provisional application No. 61/435,103, filed on Jan. 21, 2011.

(51) Int. Cl. A61D 1/02

(52) U.S. Cl. CPC A61D 1/025
USPC 604/506; 604/187

(57) ABSTRACT

Injection apparatus and methods of positioning an injection needle in an injection apparatus are described herein. The injection apparatus may include one or more axes of rotation. The injection apparatus may include an injection unit attached to a support assembly that moves between a rearward position and a forward position, with the injection unit attached to the support such that it rotates relative to the support assembly about an injection unit axis.

### RELATED APPLICATION

The present application claims the benefit under 35 U.S.C. §119 of U.S. Provisional Patent Application No. 61/435,103, titled POULTRY INJECTION APPARATUS AND METHODS and filed on Jan. 21, 2011, which is hereby incorporated by reference in its entirety

Poultry injection apparatus and methods of positioning poultry injection apparatus are described herein.

The processing of poultry may include activities such as sexing to determine gender, inoculating or otherwise medicating the birds, feeding the birds, weighing the birds, treating the beaks and/or claws of the birds (to, e.g., retard their growth), etc. Conventionally, birds are handled manually, i.e., individuals must physically hold the bird to perform the injection process.

When injecting birds to, e.g., deliver a medication or some other therapeutic substance, vitamins, or any other substance that should or could be advantageously delivered subcutaneously, the injection process may be complicated by the smaller size of the birds and their movement.

### SUMMARY

Injection apparatus and methods of positioning an injection needle are described herein. The injection apparatus may include, in various embodiments, one or more axes of rotation. For example, the injection apparatus may include an injection unit attached to a support assembly that slides in a linear direction and/or rotates about a support assembly axis, with the injection unit attached to the support assembly such that it rotates relative to the support assembly about an injection unit axis.

The linear and/or rotational movement of the components of the injection apparatus can potentially enhance positioning of an injection needle in a manner that may improve accurate and repeatable placement of an injection needle on a bird located in a fixed position relative to the injection apparatus.

Another potential advantage of the injection apparatus and methods described herein is that, in some embodiments, the linear and/or rotational motion of the different components may cause the skin of the bird to fold or bunch up at the injection location to enhance subcutaneous delivery of the substances delivered using the injection needles.

Although the injection apparatus and methods described herein may be used with birds of any age, they may be particularly useful when used with hatchlings, where “hatchlings” are defined as young birds (e.g., chickens, turkeys, ducks, geese, etc.) with an age of one week or less.

In one aspect, some embodiments of an injection apparatus as described herein may include: a support assembly attached to a frame, wherein the support assembly is configured to move, relative to the frame, between a forward position and a rearward position; an injection unit attached to the support assembly, wherein the injection unit moves with the support assembly between the forward position and the rearward position; and wherein the injection unit is configured to rotate about an injection unit axis relative to the support assembly, the injector unit rotating between a staging position and an injection position; wherein the injection unit comprises an injection needle fluidly connected to a fluid coupling and a needle actuator, wherein the needle actuator is configured to advance the injection needle from a retracted position to an advanced position.

In some embodiments of the injection apparatus, the support assembly comprises a slide support configured to move in a linear direction between the forward position and the rearward position, and the injection unit is attached to the slide support such that the injection unit moves in a linear direction with movement of the slide support, and wherein the injection unit rotates relative to the slide support when rotating about the injection unit axis. In some embodiments, the slide support is configured to rotate about a support assembly axis that is offset from the injection unit axis, and rotation of the slide support about the support assembly axis changes the orientation of the linear direction along which the slide support moves between the rearward and forward positions. In still other embodiments, the support assembly axis is aligned with the injection unit axis.

In some embodiments of the injection apparatus described herein, the support assembly comprises a support arm attached to the frame, wherein the support arm comprises a first end and a second end, wherein the support arm is configured to rotate about a support assembly axis when moving between the forward position and the rearward position, and the injection unit is attached to the support arm such that the injection unit moves in an arc about the support assembly axis when the support arm moves between the forward position and the rearward position. The support assembly may further include a support arm actuator operably attached to the support arm, wherein the support arm actuator is configured to rotate the support arm about the support assembly axis.

In some embodiments that include a rotating support arm as a part of the support assembly, the injection unit axis and the support assembly axis are aligned with each other.

In some embodiments that include a rotating support arm as a part of the support assembly, the injection needle comprises a tip that follows an injection path between the retracted position and the advanced position, wherein the injection path is located on a line that intersects the injection unit axis. In some embodiments, the line on which the injection path is located intersects the injection unit axis when the injection unit is in all positions between and including the retracted position and the advanced position. In some embodiments, the line on which the injection path is located intersects the support assembly axis when the support arm is in the forward position and the injection unit is in the injection position.

In some embodiments that include a rotating support arm as a part of the support assembly, the distance between a distal end of the needle guard and the injection unit axis is less than the distance between the distal end of the needle guard and the support assembly axis.

In some embodiments that include a rotating support arm as a part of the support assembly, rotation of the support arm about the support assembly axis from the rearward position to the forward position and rotation of the injection apparatus about the injection unit axis from the staging position to the injection position are in the same direction when viewed from the same vantage point.

In some embodiments of the injection apparatus described herein, the injection unit comprises an injection unit bias structure that is configured to apply a biasing force on the injection unit that resists rotation of the injection unit from the staging position to the injection position. In some embodiments, the injection unit bias structure is configured such that the biasing force is adjustable.

In another aspect, methods of positioning an injection needle are described herein, with the method comprising: moving a support assembly from a rearward position to a forward position; and rotating an injection unit attached to the support assembly about an injection unit axis from a staging position and an injection position, wherein the injection unit comprises a needle actuator and an injection needle fluidly connected to a fluid coupling, wherein the needle actuator is configured to advance the injection needle from a retracted position to an advanced position; wherein rotation of the injection unit about the injection unit axis from the staging position towards the injection position is initiated before the support assembly has reached its forward position.

In some embodiments of the methods described herein, the injection unit is rotating between the staging position and the injection position during at least a portion of the time the support assembly is moving between the rearward position and the forward position.

In some embodiments of the methods described herein, the injection unit is biased towards the staging position by a biasing force that resists rotation of the injection unit from the staging position to the injection position. In some embodiments, the method may include adjusting the biasing force.

In some embodiments of the methods described herein, moving the support assembly comprises moving a slide support in a linear direction between the forward position and the rearward position, and wherein the injection unit is attached to the slide support such that the injection unit moves in a linear direction with movement of the slide support. In some embodiments, the method may include rotating the slide support about a support assembly axis that is offset from the injection unit axis, wherein rotating the slide support about the support assembly axis changes the orientation of the linear direction along which the slide support moves between the rearward and forward positions.

In some embodiments of the methods described herein, moving the support assembly comprises rotating a support arm about a support assembly axis between the forward position and the rearward position, and wherein the injection unit is attached to the support arm such that the injection unit moves in an arc about the support assembly axis when the support arm moves between the forward position and the rearward position. In some embodiments, the support assembly axis and the injection unit axis are aligned with each other.

In some embodiments of the methods described herein that include rotating a support arm between a rearward and a forward position, the injection needle comprises a tip that follows an injection path between the retracted position and the advanced position, and wherein the injection path is located on a line that intersects the injection unit axis. In some embodiments, the line on which the injection path is located intersects the injection unit axis when the injection unit is in all positions between and including the staging position and the injection position. In some embodiments, the line on which the injection path is located intersects the support assembly axis when the support arm is in the forward position and the injection unit is in the injection position.

In some embodiments of the methods described herein that include rotating a support arm between a rearward and a forward position, the distance between a distal end of the needle guard and the injection unit axis is less than the distance between the distal end of the needle guard and the support assembly axis.

In some embodiments of the methods described herein that include rotating a support arm between a rearward and a forward position, rotation of the support arm about the support assembly axis from the rearward position to the forward position and rotation of the injection apparatus about the injection unit axis from the staging position to the injection position are in the same direction when viewed from the same vantage point.

In another aspect, the injection apparatus described herein may include a slide assembly attached to a frame, wherein the slide assembly comprises a slide support configured to move in a linear direction between a forward position and a rearward position relative to the frame; an injection unit attached to the slide support, wherein the injection unit is configured to rotate about an injection unit axis relative to the slide assembly, the injector unit rotating between a staging position and an injection position; wherein the injection unit comprises an injection needle fluidly connected to a fluid coupling and a needle actuator, wherein the needle actuator is configured to advance the injection needle from a retracted position to an advanced position.

In another aspect, the injection apparatus described herein may include a support assembly comprising a support arm and a support arm actuator operably attached to the support arm, wherein the support arm is configured to rotate about a support assembly axis relative to a frame to which the support assembly is attached, wherein the support arm actuator is configured to rotate the support arm about the supply assembly axis between a rearward position and a forward position; and an injection unit attached to the support arm, wherein the injection unit is configured to rotate about an injection unit axis relative to the support arm between a staging position and an injection position, wherein the injection axis is displaced from the supply assembly axis; wherein the injection unit comprises an injection needle fluidly connected to a fluid coupling and a needle actuator, wherein the needle actuator is configured to advance the injection needle from a retracted position to an advanced position.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, an injection needle may refer to one or more injection needles unless otherwise indicated.

The term “and/or” means one or all of the listed elements or a combination of any two or more of the listed elements.

The above summary is not intended to describe each embodiment or every implementation of the present invention. Rather, a more complete understanding of the injection apparatus and methods described herein will become apparent and appreciated by reference to the following Description of Illustrative Embodiments and claims in view of the accompanying figures of the drawing.

### BRIEF DESCRIPTION OF THE VIEWS OF THE DRAWING

The present invention will be further described with reference to the views of the drawing, wherein:

FIG. 1 is side view of one illustrative embodiment of an injection apparatus as described herein with a bird in a bird carrier positioned therein, wherein the support arm of the support assembly is in the rearward position and the injection unit is in the staging position;

FIG. 2 is a view of the injection apparatus of FIG. 1 with the bird removed from the bird carrier, the view being taken from the left side of the injection apparatus as seen in FIG. 1;

FIG. 3 is a side view of the injection apparatus of FIG. 1 with the bird and bird carrier removed, wherein the support arm is in the rearward position and the injection unit is in the staging position;

FIG. 4 is a view of the injection apparatus of FIG. 3, wherein the support arm is in between the rearward position and the forward position, and wherein the injection unit is in the staging position; and

FIG. 5 is a view of the injection apparatus of FIG. 3, wherein the support arm is in the forward position and the injection unit is in the injection position.

FIG. 6 is a side view of an alternative illustrative embodiment of an injection apparatus as described herein, wherein the support assembly is in the rearward position.

FIG. 7 is a side view of the injection apparatus of FIG. 6 with the support assembly advanced to its forward position.

### DESCRIPTION OF ILLUSTRATIVE EMBODIMENTS

In the following description of illustrative embodiments, reference is made to the accompanying figures of the drawing which faun a part hereof, and in which are shown, by way of illustration, specific embodiments in which the carriers and methods described herein may be practiced. It is to be understood that other embodiments may be utilized and structural changes may be made without departing from the scope of the present invention.

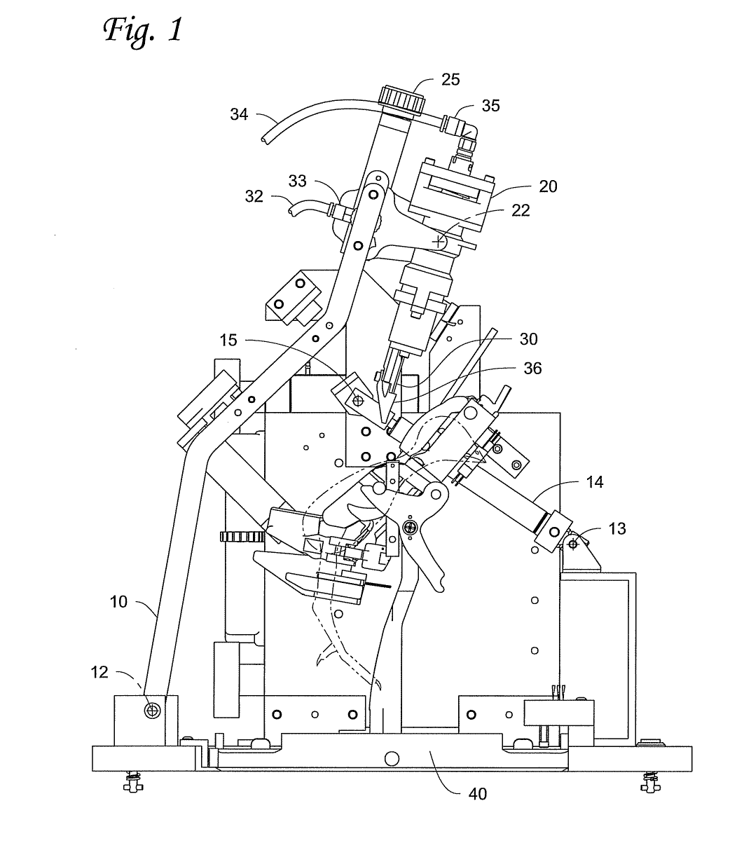

One illustrative embodiment of an injection apparatus and methods of positioning an injection needle as described herein are depicted in connection with FIGS. 1-5. The injection apparatus and methods described herein are adapted to subcutaneously inject materials into birds that are carried in poultry carriers similar to those described in International Publication No. WO 2010/085718 titled POULTRY CARRIERS AND METHODS OF RESTRAINING POULTRY. It should, however, be understood that the injection apparatus and methods described herein may be used in the absence of those carriers, e.g., the birds to be processed using the injection apparatus and methods described herein may be held in any suitable jig, fixture, etc. that positions the bird properly for processing.

Further, the injection apparatus and methods described herein may be used in processing systems and methods such as those described in U.S. Pat. No. 7,066,112, titled AUTOMATED POULTRY PROCESSING METHOD AND SYSTEM. The injection apparatus and methods described herein may also be used in other systems or environments where transport and/or processing of birds is performed.

One illustrative embodiment of an injection apparatus as described herein is depicted in side views in FIGS. 1-5. The injection apparatus includes a support assembly that includes a support arm 10 that is mounted for rotation about a support assembly axis 12 that, in the depicted embodiment, extends through a frame on which the support arm 10 is mounted. The frame on which the support arm 10 is mounted may preferably be stationary such that the support arm 10 rotates about support assembly axis 12 to move the upper end of the support arm 10 relative to the frame.

Rotation of the support arm 10 around the axis 12 can be accomplished using many different actuation mechanisms. One example of a potential mechanism for rotating the support arm 10 about the axis 12 is depicted in FIGS. 1-5. The mechanism that rotates the support arm 10 is in the form of a bidirectional piston 14 that is connected to the frame at location 13 and to the support arm 10 at location 15. The bidirectional piston 14 is preferably mounted for rotation at both ends, i.e., the bidirectional piston 14 preferably rotates around an axis that extends through location 13 as well as an axis that extends through location 15 where the bidirectional piston 14 is attached to the support arm 10. Other actuation mechanisms may be used in place of a bidirectional piston to obtain the motion needed to rotate the support arm 10 as described herein, e.g., a rack and pinion, magnetic drive systems, solenoids, etc.

Also depicted in connection with the illustrative embodiment of FIG. 1 is an injection unit 20 which is attached to the support arm 10. The injection unit 20 is also preferably mounted such that it rotates about an injection unit axis 22 relative to the support arm 10. The injection unit axis 22 around which the injection unit 20 rotates is preferably displaced from the support assembly axis 12 about which the support arm 10 rotates. In other words, the support assembly axis 12 and the injection unit axis 22 do not lie on the same line, i.e., are not co-linear. In some embodiments, however, it may be preferred that the support assembly axis 12 and the injection unit axis 22 are aligned with each other (although offset from each other). In some embodiments in which the axes are aligned, the support assembly axis 12 and injection unit axis 22 may be parallel with each other, although it should be understood that, as used herein, “parallel” axes need not necessarily be perfectly parallel with each other.

The injection unit 20 includes an injection needle 30 that is used to subcutaneously deliver vaccines or other materials to a bird as described herein. The injection needle 30 is preferably advanced using a needle actuator that is configured to advance the injection needle 30 from a retracted position in which the tip of the needle is not exposed to an advanced position in which the tip of the needle is exposed and capable of piercing the skin of a bird located in the injection apparatus.

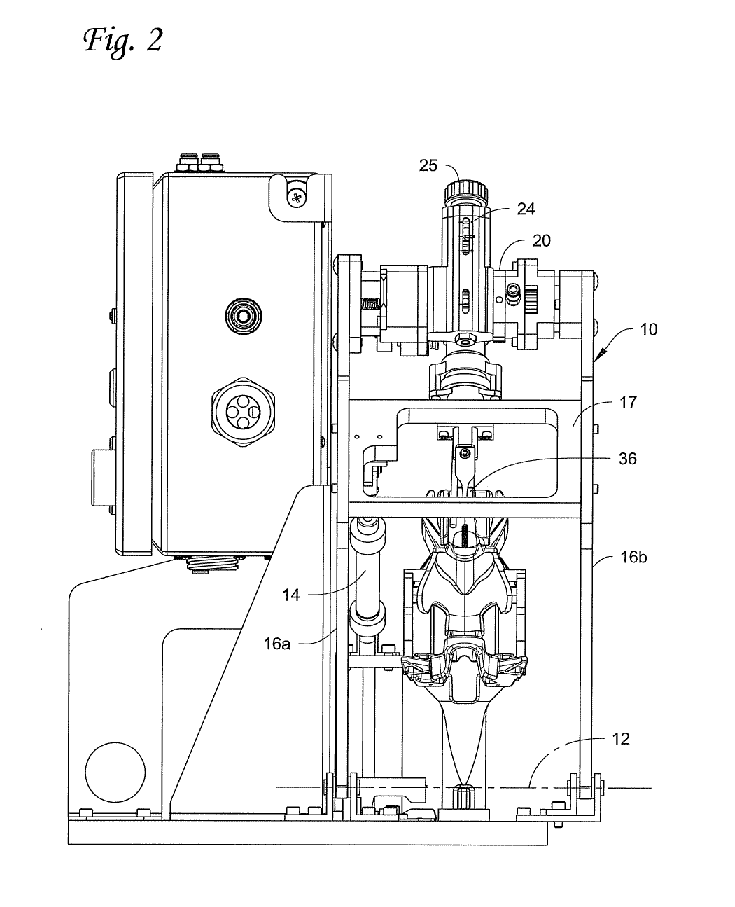

As seen in FIG. 2, the support arm 10 of the support assembly of the depicted embodiment includes a pair of struts 16a and 16b that are connected to each other by a spanning member 17 as well as the injection unit 20. Taken together, these different members provide the support arm 10 with sufficient rigidity and racking strength to perform the functions required in the injection apparatus. It will be appreciated that some features seen in FIGS. 1 and 3-5 have been removed from FIG. 2 (e.g., the fluid fittings and lines 32, 33, 34, and 35). Further, the specific structure of arm 10 is exemplary in nature only, i.e., many different structures could be used to accomplish the functions required of the support arm as described herein.

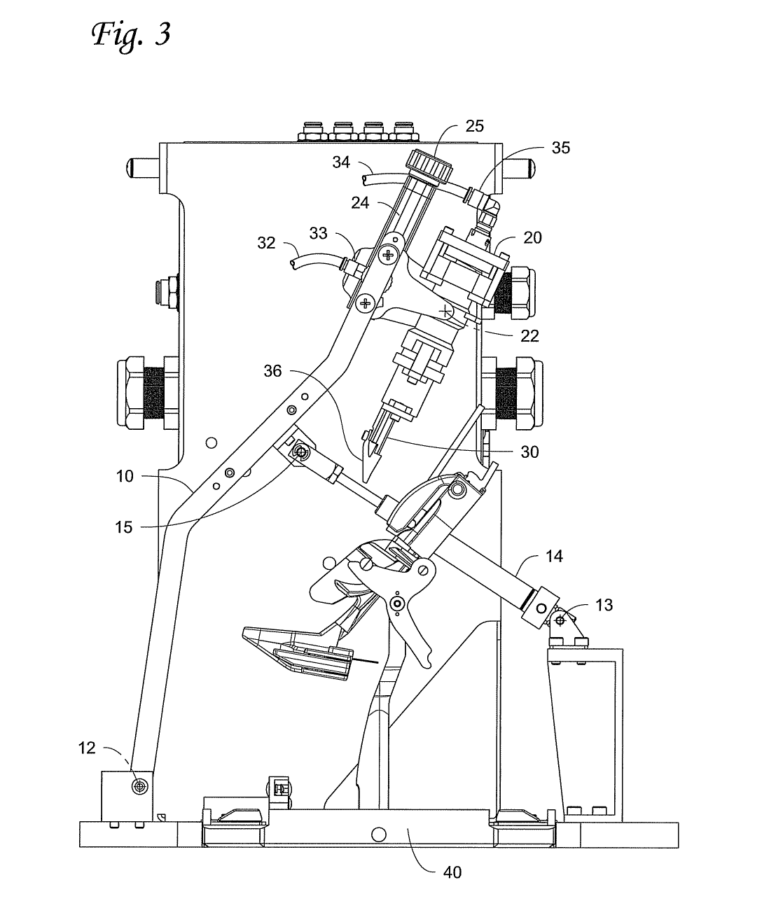

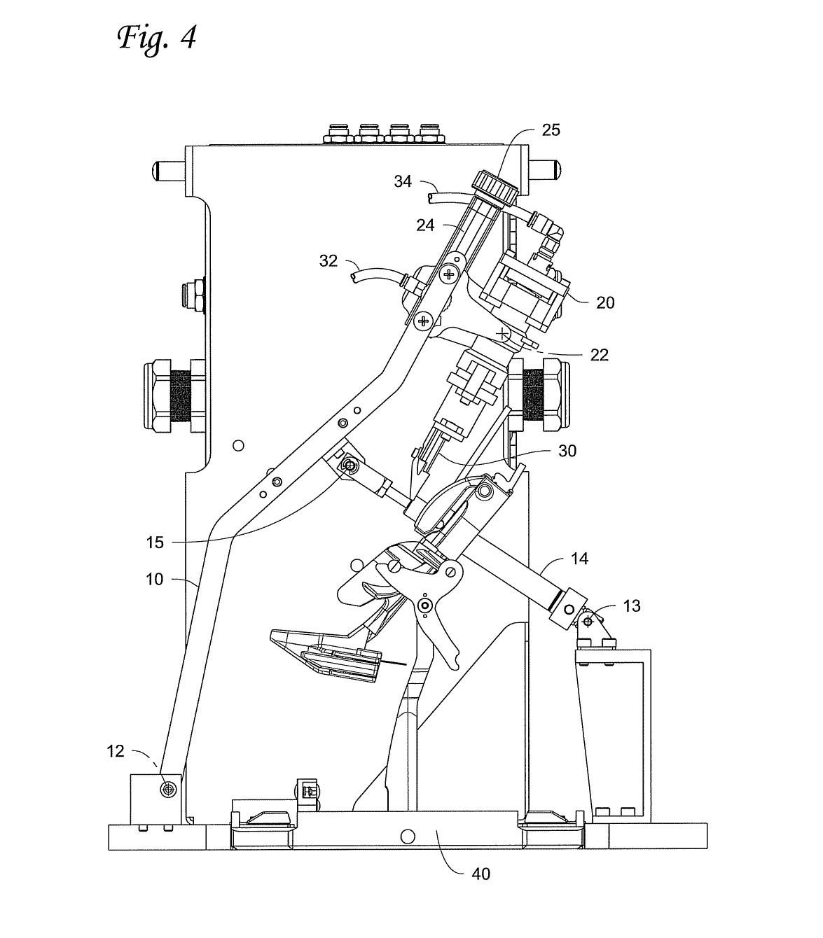

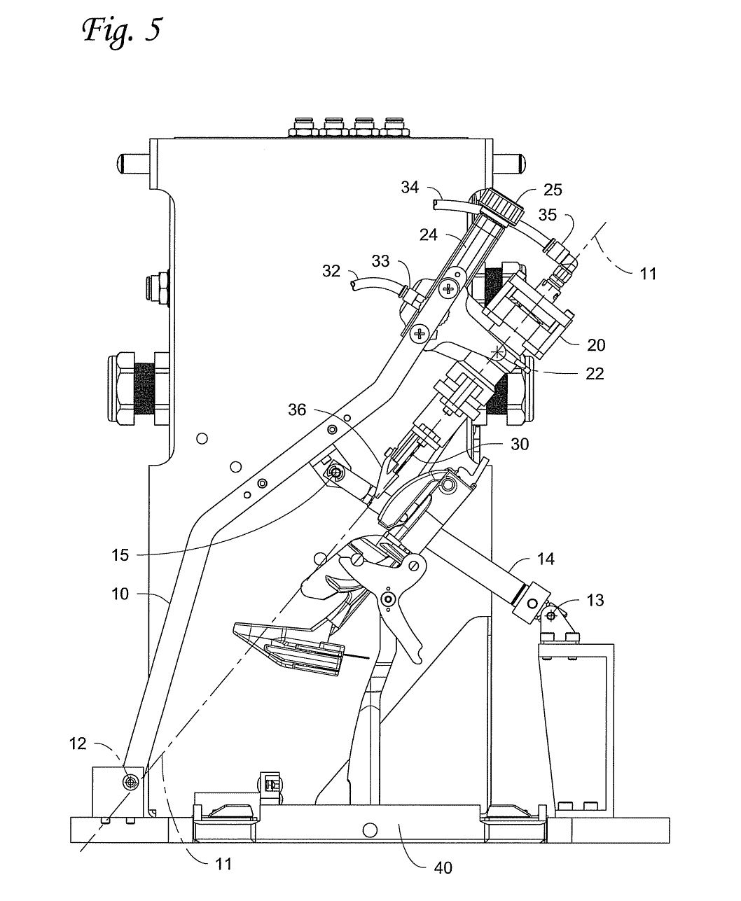

In the sequence of FIGS. 3-5, movement of the support arm 10 from its rearward position to its forward position and movement of the injection unit 20 from its staging position to its injection position is depicted. In particular, the support arm 10 is in its rearward position and the injection unit 20 is in its staging position in FIG. 3, while the support arm 10 is in its forward position and the injection unit 20 is in its injection position in FIG. 5. FIG. 4 depicts the support arm 10 in a position that is intermediate, i.e., between, the rearward position and the forward position. Also seen in FIG. 4 is the fact that the injection unit 20 stays in its staging position during rotation of the support arm 10 from its rearward position towards its forward position.

In the absence of a bird located in a carrier 40 in the inoculation position within the injection apparatus, the injection unit 20 would, in some embodiments, remain in the staging position throughout movement of the support arm 10. Where, however, a bird in a carrier 40 is located in the inoculation position within the injection apparatus as depicted in FIG. 1, rotation of the support arm 10 from its rearward position as seen in FIG. 3 to its forward position as seen in FIG. 5, the injection needle guard 36 will contact the bird before the support arm 10 reaches its forward position. As a result of that contact, the injection unit 20 is rotated about injection unit axis 22 until it is preferably in an orientation that is similar to that seen in FIG. 5. In some embodiments, rotation of the injection unit 20 about the injection unit axis 22 may be initiated when the needle guard 36 of the injection unit 20 contacts a bird before the support arm 10 has reached its forward position.

Another feature depicted in connection with FIG. 5 is the alignment of the various components along the axis 11 as seen in FIG. 5. For example, in the depicted embodiment, axis 11 extends through both support assembly axis 12 and the injection unit axis 22 and, in addition, the injection needle 30 may be aligned along axis 11 when the injection needle 30 is in its injection position. As a result, the injection path followed by the tip of the injection needle 30 is also located along axis 11. It should be understood, however, that this arrangement of components is optional and need not necessarily be present in all embodiments of the injection apparatus described herein.

Rotation of the injection unit 20 about injection unit axis 22 may, in some embodiments, preferably be resisted by an injection unit bias structure that is attached between the support arm 10 and the injection unit 20. The injection unit bias structure may preferably be configured to apply a biasing force on the injection unit 20 that resists rotation of the injection unit 20 about the injection unit axis 22 from its staging position to its injection position. In other words, the injection unit 20 may be biased into the staging position by the injection unit bias structure.

In the depicted embodiment, the injection unit bias structure may be provided in the form of a coil spring or other resilient member located in a sleeve 24 with the force applied by the injection unit bias structure to resist rotation of the injection unit 20 being adjusted by rotation of a knob 25. Many other bias structures may be used in place of that depicted in the embodiment seen in FIGS. 1-5. Furthermore, although the illustrative embodiment of an injection unit bias structure is described as providing an adjustable biasing force, that is not a necessary component or function of the injection apparatus described herein.

The injection unit 20 of the embodiment depicted in FIGS. 1-5 includes, as described herein, an injection needle 30. The injection needle 30 includes a tip that can be described as following an injection path between a retracted position and an advanced position. It may be preferred that, in some embodiments, the injection path followed by the tip of the injection needle 30 being located on a line that intersects the injection unit axis 22 about which the injection unit 20 rotates as described herein. Further, in some embodiments, the injection path followed by the tip of the injection needle 30 may, in all positions between and including the retracted position and the advanced position, be located on a line that intersects the support assembly axis 22. Referring to FIG. 5, for example, the injection path may be located on axis 11.

Although not required, in some embodiments the location of a bird in the inoculation position may cause rotation of the injection unit 20 about injection unit axis 22 such that the injection path followed by the tip of the injection needle 30 is located on a line that also extends through support assembly axis 12 about which support arm 10 rotates as described herein. This arrangement is not, however, required.

In another manner of characterizing the relationships between the support arm 10, the support assembly axis 12 and the injection unit 22, the distance between a distal end of the injection needle guard 36 and the injection unit axis 22 about which the injection unit 20 rotates may preferably be less than the distance between the support assembly axis 12 and the injection unit axis 22. The distal end of the needle guard 36 is the portion of the needle guard 36 that is located furthest from the injection unit axis 22.

In still another manner of characterizing the relationships between the various components of the injection apparatus depicted in FIGS. 1-5, the injection needle may preferably be located between the support assembly axis 12 (about which the support arm 10 rotates) and the injection unit axis 22 (about which the injection unit 20 rotates) when the injection apparatus is viewed from the same vantage point, such as, e.g., the vantage point used in FIGS. 1 and 3-5.

In yet another manner of characterizing the injection apparatus described herein, the direction of rotation of the various components may be such that the support arm 10 and the injection unit 20 rotate about their respective axes 12 and 22 in the same direction. For example, as seen in FIGS. 1-5, rotation of the support arm 10 from the rearward position to the forward position is in a clockwise direction and, similarly, rotation of the injection unit 20 about injection unit axis 22 from its staging position to its injection position is also in a clockwise direction. The direction of rotation of these components is, of course, dependent on the side from which the injection apparatus is viewed. For example, if the injection apparatus depicted in FIGS. 1-5 were viewed from the opposite side, the direction of rotation of the various components would be counterclockwise rather than clockwise as described above. Regardless, however, in both instances the directions of rotation of the support arm 10 and the injection unit 20 would be in the same direction.

Among the other components and features depicted in the illustrative embodiment of the injection apparatus of FIGS. 1-5, are the fluid lines 32 and 34. Fluid line 32 is connected to a fitting 33 that is in fluid communication with a piston located within the injection unit 20. The piston located within injection unit 20 is used to advance and/or retract the injection needle 30 through the injection needle guard 36 to inject material into a bird as described herein. In some embodiments a piston may be used only to advance the injection needle 30, while another element, e.g., a spring or other resilient element, may be used to retract the injection needle 30 after it has been advanced to inject material into a bird located within the injection apparatus. Other mechanisms may also be used to move the injection needle 30 between its retracted position and advanced position, e.g., motors, solenoids, magnetic drive systems, etc.

In some embodiments, the needle guard 36 may include one or more features to assist in proper placement of the injection needle 30. Such features could include, e.g., structures (such as, e.g., barbs, posts, and other surface features), the use of tacky materials such as adhesives, silicones, and other materials that tend to grip the surface of the bird, etc.

In some embodiments of the injection apparatus described herein, the position of the injection needle guard 36 relative to the injection unit axis 22 can be adjusted to compensate for variations in the position of the bird relative to the injection unit 20, the size of the birds being processed by the injection apparatus, and other features or characteristics. Further, in some embodiments, the force with which the injection needle 30 is advanced may be adjusted depending on the birds being processed and other factors (e.g., the size of the needle, etc.).

The injection apparatus depicted in FIGS. 1-4 also includes fluid line 34 that is connected to a fitting 35 on the injection unit 20. The fluid line 34 may be used, in the depicted embodiment, to deliver material that is injected into a bird using the injection needle 30. The fluid line 34 is, therefore, typically connected to a source of the material to be injected (not shown). In other embodiments, however, it should be understood that the injection unit 20 may itself contain a reservoir of fluid that is to be delivered using the injection needle 30. In such an embodiment, a fluid line 34 need not be used to supply fluid for injection using the injection needle 30 of the injection unit 20.

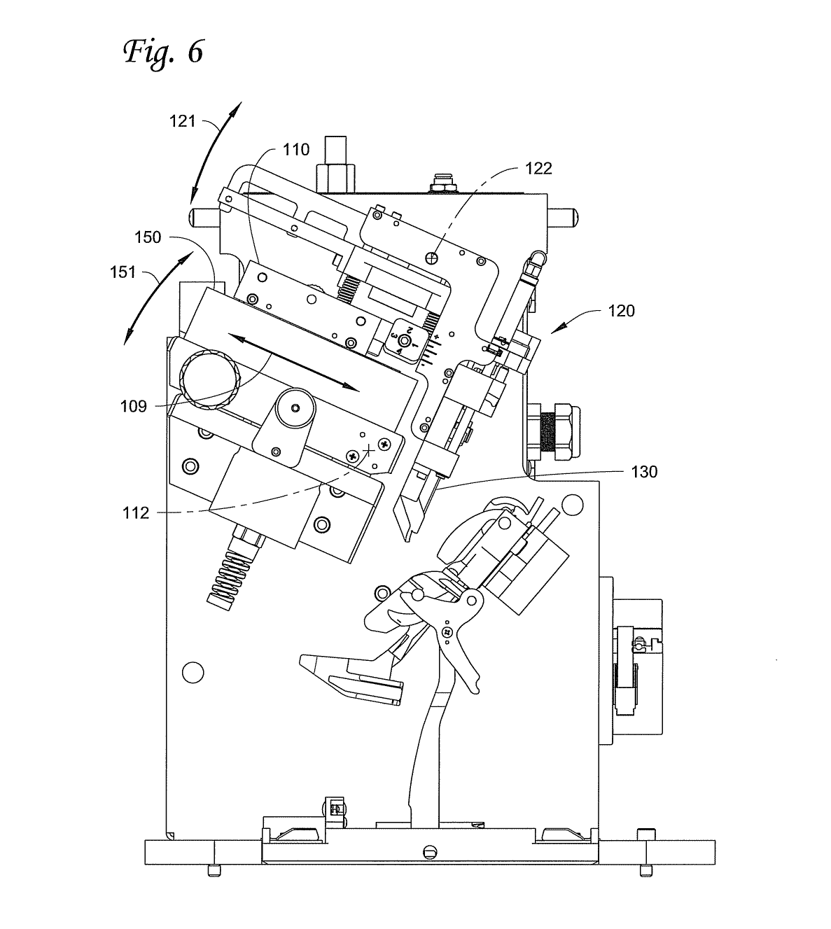

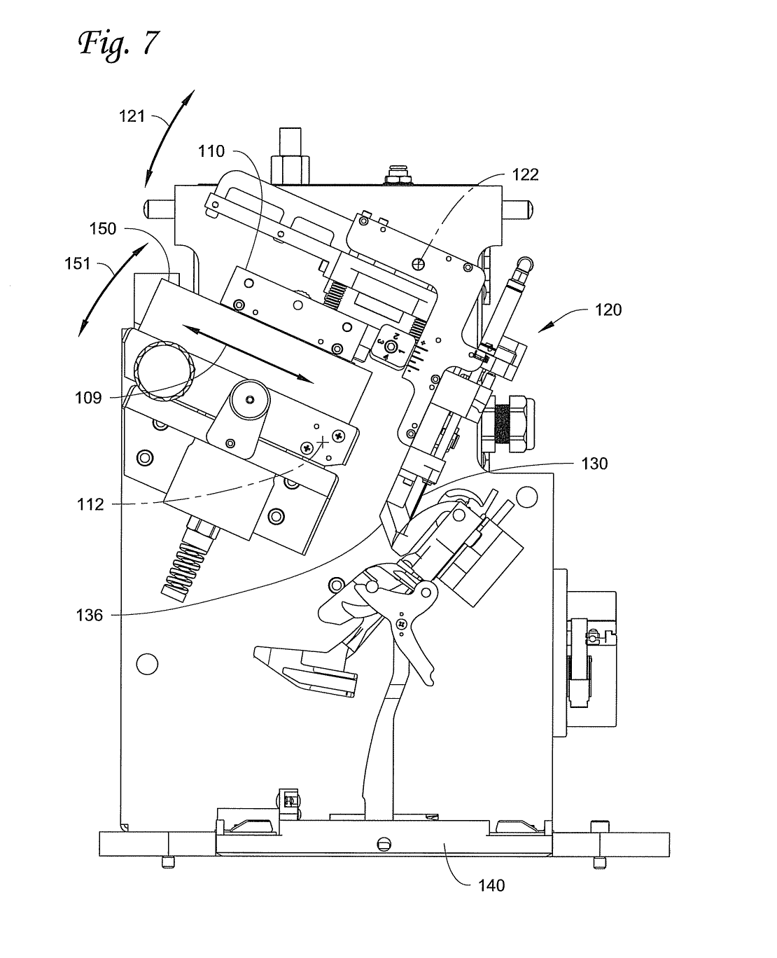

Referring now to FIGS. 6 and 7, an alternative illustrative embodiment of an injection apparatus and methods of positioning an injection needle are depicted and will be described. The injection apparatus includes a support assembly attached to a frame. The support assembly includes a slide support 110 that is configured to move between a forward position and a rearward position in a linear direction depicted by bidirectional arrow 109 in FIG. 6. The slide support 110 is mounted on a base 150 which typically remains stationary while the slide support 110 moves between its rearward and forward positions.

The orientation or angle of the linear direction 109 along which the support slide 110 moves between its rearward and forward positions may be adjusted by rotating the support assembly about a support assembly axis 112. Although the support assembly axis 112 is located within the boundaries of the support assembly in the depicted embodiment (in particular, within the boundaries of the base 150, the support assembly axis 112 could be located in any other suitable location outside of the boundaries of the support assembly. In the depicted embodiment, rotation of the support assembly involves rotating the base 150 and the attached support slide about the axis 112. The direction of rotation of the support slide 110 about the support assembly axis 112 is indicated by arc 151 in FIGS. 6 and 7.

Unlike rotation of the support 10 in the embodiment of the injection apparatus depicted in FIGS. 1-5, in which the support arm 10 rotates to put the injection apparatus 20 into contact with a bird, rotation of the support assembly in the injection apparatus embodiment depicted in FIGS. 6 and 7 is performed outside of the normal operation of the injection apparatus and may not typically be adjusted during actual use of the injection apparatus. In other words, the rotational position of the support assembly relative to the support assembly axis 112 (and, therefore, the orientation of the linear direction 109), will typically be adjusted separately and fixed in position so that movement of the support slide 110 as a part of actual use of the injection apparatus will be pure linear motion.

Movement of the slide support 110 in the linear direction 109 can be accomplished using many different actuation mechanisms. One example of a potential mechanism for moving the slide support 110 relative to the base 150 may include, e.g., a bidirectional piston, a rack and pinion, magnetic drive systems, solenoids, etc.

Also depicted in connection with the illustrative embodiment of FIGS. 6 and 7 is the injection unit 120 which is attached to the support slide 110. Because the injection unit 120 is attached to the support slide 110 of the support assembly, rotation of the support assembly about the support assembly axis 112 will also rotate the injection unit 120 about the support assembly axis 112. Movement of the support slide 110 in the linear directions of arrow 109 will also move the injection unit 120 in the same linear directions. The injection unit 120 is also preferably mounted such that it rotates about an injection unit axis 122 relative to the support slide 110.

The injection unit 120 includes an injection needle 130 that is used to subcutaneously deliver vaccines or other materials to a bird as described herein. The injection needle 130 is preferably advanced using a needle actuator that is configured to advance the injection needle 130 from a retracted position in which the tip of the needle is not exposed to an advanced position in which the tip of the needle is exposed and capable of piercing the skin of a bird located in the injection apparatus. In most respects, the injection unit 120 is preferably similar to the injection unit 20 depicted in FIGS. 1 and 3-5.

The linear movement of the support slide 110 can be seen by comparing FIG. 6 to FIG. 7. The support slide 110 is in its rearward position in FIG. 6 and in its forward position in FIG. 7. In addition, the injection unit 120 is in its staging position (with respect to the injection axis 122) in FIG. 6. The injection unit 120 will typically remain in its staging position during movement of the support slide 110 from its rearward position (FIG. 6) towards its forward position (FIG. 7) unless or until the needle guard encounters resistance (such as, e.g., a bird).

In the absence of a bird located in a carrier 140 in the inoculation position within the injection apparatus, the injection unit 120 would, in some embodiments, remain in the staging position throughout movement of the support slide 110. Where, however, a bird in a carrier 140 is located in the inoculation position within the injection apparatus (e.g., as depicted in FIG. 1), movement of the support slide 110 from its rearward position as seen in FIG. 6 to its forward position as seen in FIG. 7 will typically cause the injection needle guard 136 to contact the bird before the support slide 110 reaches its forward position. As a result of that contact, the injection unit 120 would rotate about injection unit axis 122 in a manner similar to the rotation of injection unit 20 as depicted in FIGS. 4 and 5. In some embodiments, rotation of the injection unit 120 about the injection unit axis 122 may be initiated when the needle guard 136 of the injection unit 120 contacts a bird before the support slide 110 has reached its forward position. The direction of rotation of the injection unit 120 about the injection unit axis 122 is indicated by arc 121 in FIGS. 6 and 7.

Rotation of the injection unit 120 about injection unit axis 122 may, in some embodiments, preferably be resisted by an injection unit bias structure that is attached between the support slide 110 and the injection unit 120. The injection unit bias structure may preferably be configured to apply a biasing force on the injection unit 120 that resists rotation of the injection unit 120 about the injection unit axis 122 from its staging position to its injection position. In other words, the injection unit 120 may be biased into the staging position by the injection unit bias structure.

In the depicted embodiment, the injection unit bias structure may be provided in the form of a coil spring or other resilient member with the force applied by the injection unit bias structure to resist rotation of the injection unit 120. Any suitable bias structures may be used in connection with the injection unit 120 so long as rotation of the injection unit 120 is resisted. In some embodiments, the injection unit bias structure may provide an adjustable biasing force, i.e., a force that may be changed as needed, but that is not a necessary component or function of the injection apparatus described herein.

Another adjustment that may be made in some embodiments of the injection apparatus depicted in FIGS. 6 & 7 is that the position of the injection unit 120 relative to the support slide 110 may be changed. For example, the position of the support slide 110 (and, thus, the injection unit 120) along the linear direction 109 relative to the base 150 of the support assembly can be adjusted. That adjustment could be used to, for example, change the position at which the needle guard 136 would contact a bird located in the carrier 140 during advancement of the support slide to its forward position.

Another adjustment that may be made in some embodiments is in the vertical position of the injection unit 120 relative to the support slide 110, where the vertical adjustment is in a direction that is essentially perpendicular to the linear direction 109. That adjustment could be used to, for example, change the position at which the needle guard 136 would contact a bird located in the carrier 140 during advancement of the support slide to its forward position. The vertical adjustment could be used to, for example, change the location at which the needle guard 136 would contact a bird located in the carrier 140.

The injection apparatus and related components may be manufactured of any suitable materials, e.g., metals, plastics, etc. In some instances, it may be beneficial if the materials have selected physical characteristics, such as, e.g., electrical conductivity, thermal conductivity, etc.

The complete disclosure of the patents, patent documents, and publications cited in the Background, the Description of Illustrative Embodiments, and elsewhere herein are incorporated by reference in their entirety as if each were individually incorporated.

Exemplary embodiments of the injection apparatus and methods described herein have been discussed and reference has been made to possible variations. These and other variations and modifications will be apparent to those skilled in the art without departing from the scope of the invention, and it should be understood that this invention is not limited to the illustrative embodiments set forth herein. Accordingly, the invention is to be limited only by the claims provided below and equivalents thereof.

1. An injection apparatus for vaccinating a live bird, the apparatus comprising:
a support assembly attached to a frame, wherein the support assembly is configured to move, relative to the frame, between a forward position and a rearward position, wherein the support assembly comprises:
a support arm comprising a first end and a second end, wherein the support arm is configured to rotate about a support assembly axis when moving between the forward position and the rearward position; and
a support arm actuator operably attached to the support arm, wherein the support arm actuator is configured to rotate the support arm about the support assembly axis;
an injection unit attached to the support arm such that the injection unit moves in an arc about the support assembly axis when the support arm moves between the forward position and the rearward position, and wherein the injection unit is configured to rotate about an injection unit axis relative to the support assembly, the injector unit rotating between a staging position and an injection position;
wherein the injection unit comprises an injection needle fluidly connected to a fluid coupling and a needle actuator, wherein the needle actuator is configured to advance the injection needle from a retracted position to an advanced position.

2-5. (canceled)

6. An injection apparatus according to claim 1, wherein the injection unit axis and the support assembly axis are aligned with each other.

7. An injection apparatus according to claim 1, wherein the injection needle comprises a tip, and wherein the tip of the injection needle follows an injection path between the refracted position and the advanced position, wherein the injection path is located on a line that intersects the injection unit axis.

8. An injection apparatus according to claim 7, wherein the line on which the injection path is located intersects the injection unit axis when the injection unit is in all positions between and including the refracted position and the advanced position.

9. An injection apparatus according to claim 7, wherein the line on which the injection path is located intersects the support assembly axis when the support arm is in the forward position and the injection unit is in the injection position.

10. An injection apparatus according to claim 1, wherein the distance between a distal end of the needle guard and the injection unit axis is less than the distance between the distal end of the needle guard and the support assembly axis.

11. An injection apparatus according to claim 1, wherein rotation of the support arm about the support assembly axis from the rearward position to the forward position and rotation of the injection apparatus about the injection unit axis from the staging position to the injection position are in the same direction when viewed from the same vantage point.

12. An injection apparatus according to claim 1, wherein the injection unit comprises an injection unit bias structure that is configured to apply a biasing force on the injection unit that resists rotation of the injection unit from the staging position to the injection position.

13. An injection apparatus according to claim 12, wherein the injection unit bias structure is configured such that the biasing force is adjustable.

14. A method of positioning an injection needle, the method comprising:
moving a support assembly from a rearward position to a forward position; and
rotating an injection unit attached to the support assembly about an injection unit axis from a staging position and an injection position, wherein the injection unit comprises a needle actuator and an injection needle fluidly connected to a fluid coupling, wherein the needle actuator is configured to advance the injection needle from a refracted position to an advanced position;
and wherein rotation of the injection unit about the injection unit axis from the staging position towards the injection position is initiated before the support assembly has reached its forward position.

15. A method according to claim 14, wherein the injection unit is rotating between the staging position and the injection position during at least a portion of the time the support assembly is moving between the rearward position and the forward position.

16. A method according to claim 14, wherein the injection unit is biased towards the staging position by a biasing force that resists rotation of the injection unit from the staging position to the injection position.

17. A method according to claim 16, wherein the method comprises adjusting the biasing force.

18-19. (canceled)

20. A method according to claim 14, wherein moving the support assembly comprises rotating a support arm about a support assembly axis between the forward position and the rearward position, and wherein the injection unit is attached to the support arm such that the injection unit moves in an arc about the support assembly axis when the support arm moves between the forward position and the rearward position.

21. A method according to claim 20, wherein the support assembly axis and the injection unit axis are aligned with each other.

22. A method according to claim 20, wherein the injection needle comprises a tip that follows an injection path between the retracted position and the advanced position, and wherein the injection path is located on a line that intersects the injection unit axis.

23. A method according to claim 22, wherein the line on which the injection path is located intersects the injection unit axis when the injection unit is in all positions between and including the staging position and the injection position.

24. A method according to claim 22, wherein the line on which the injection path is located intersects the support assembly axis when the support arm is in the forward position and the injection unit is in the injection position.

25. A method according to claim 20, wherein the distance between a distal end of the needle guard and the injection unit axis is less than the distance between the distal end of the needle guard and the support assembly axis.

26. A method according to claim 20, wherein rotation of the support arm about the support assembly axis from the rearward position to the forward position and rotation of the injection apparatus about the injection unit axis from the staging position to the injection position are in the same direction when viewed from the same vantage point.

27-28. (canceled)
